(19) United States
(12) Patent Application Publication
(10) Pub. No.: US 2017/0263155 A1
(43) Pub. Date: Sep. 14, 2017

(54) SIMPLIFIED CIRCUIT BUILDING BLOCK DEVICE AND METHOD OF USE

(71) Applicants: Joseph T. Broms, Ontario, WI (US); Christopher Broms, Ontario, WI (US)

(72) Inventors: Joseph T. Broms, Ontario, WI (US); Christopher Broms, Ontario, WI (US)

(21) Appl. No.: 15/457,977

(22) Filed: Mar. 13, 2017

Related U.S. Application Data
(60) Provisional application No. 62/307,286, filed on Mar. 11, 2016.

(51) Int. Cl. G09B 23/18; A63H 33/08; A63H 33/04

(52) U.S. Cl. CPC G09B 23/185; A63H 33/042; A63H 33/08

(57) ABSTRACT

A circuit building device and method for use. The circuit building device is configured to resemble a construction-style brick including various knobs and receptacles for cooperating engagement. The shape and features of various specialized bricks and hubs allows for improved circuit construction and learning.

### CROSS REFERENCE TO RELATED APPLICATIONS

This application claims priority to U.S. Provisional Patent Application No. 62/307,286 filed 11 Mar. 2016 to the above named inventor, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present invention relates to an electronic circuit-building toy designed to teach digital logic through building blocks.

### BACKGROUND OF THE INVENTION

Traditionally, one of the best toys for a developing child is blocks for building. Building blocks help to develop fine motor skills, stimulate creativity, enhance math and vocabulary comprehension, and encourage positive social interactions. One of the most well-known and popular construction-style building block based toys is LEGO branded building blocks. These blocks are generally rectangular in shape and define an interior cavity with centralized inner tubes positioned within the cavities. The top side of the blocks include a plurality generally raised cylinders arranged in a manner and sized for engagement with the underside of a companion block, wherein the blocks are easily and quickly assembled and disassembled into shapes and structures.

Traditional electronic circuit assemblies and construction methods require an advanced knowledge of logic, wiring, assembly with solder, small parts, attention to detail, and can be very time consuming. These circuits are not easily assembled and not easily understood.

Within the prior art, there exist circuit related toy sets and assemblies that are designed to increase a user's general knowledge of circuitry and enable the building of related devices. These systems are specifically designed for this use and are not compatible with additional and commonly available accessories and blocks.

Therefore, there is a need for an improved circuit building toy and device that exposes children to digital logic in an easier way. Preferably, this device and system utilizes traditional building block features and is assembled in a similar manner. Still further, it is desired that this system and method utilize a specialized circuit placed within a physical enclosure resembling a common construction-style building block, such as a LEGO branded building block to maintain compatibility with these types of construction style building blocks.

### SUMMARY OF THE INVENTION

The device of the present invention relates to a specialized circuit with a functional resemblance to a solderless breadboard configured within the physical enclosure of a construction-style building block. Within this configuration, the user can assemble the circuit similar to a building block and wherein individual specialized building bricks are assembled to a main hub brick to create completed circuits.

The main hub brick of the present invention is sized and shaped to resemble a rectangular construction-style building brick, as is commonly known in the prior art, and having a hollow cavity inner portion with a centralized inner tube and cylindrically shaped raised knobs arranged in horizontal rows and vertical columns on a top side of the building brick. The main hub brick receives an incoming direct current (DC) power source and Universal Asynchronous Receiver/Transmitter (UART) connection and structural elements to distribute this power and data with a number of hubs or peripherals, hereinafter referred to as “downlinks,” and positioned on the raised knobs of the main hub brick.

The main hub is comprised of six (6) horizontal rows of knobs and a fixed number of columns of knobs, hereinafter the number of rows and the number of columns are designated in the following convention: (number of horizontal rows×number of columns). The central two rows of these horizontal rows of knobs are dedicated as downlinks in a two by two (2×2) pattern with the opposed pairs comprised of a powered knob, a ground knob, a transmission knob, and a receiving knob. These downlinks include circuitry for performing Analog to Digital Converter (ADC) measurements. The ability to perform measurements is essential to simplifying and lowering system cost, as some of the specialized bricks placed upon the downlinks are merely bricks with a pair of resistors. The hub can detect these combinations and use this to emulate part of the circuit under its control. Additionally, the ADC measurements allow for the placement of specialized bricks that utilize only analog elements, such as, but not limited to, resistors, capacitors, diodes, and inductors, for use in specialized rotational switches and pushbutton-style bricks utilizing only these analog elements.

The exterior two (2) horizontal rows of the main hub are preferably comprised of a light emitting diode (LED) positioned inner the exterior row and adjacent to the central rows and input/output (IO) pins on the exterior row and adjacent to the LED.

When the specialized bricks are placed on the downlink pairs of the main hub, the associated LED and IO columns aligned with the specialized brick become dedicated to that particular specialized brick. On such specialized brick is a 2×2 wire brick. This 2×2 wire brick allows the downlink to be physically connected to another hub or peripheral device positioned away from the hub, allowing the device to be expanded to a larger area.

Another such specialized brick is a root brick. The root brick includes an uplink providing a connection to a computing device through a Universal Serial Bus (USB) connection, wirelessly through radio waves, such as the Bluetooth communication protocol, or independently with some access to power, either through USB or a battery powered source.

The physical assembly of the hubs and bricks is generally comprised of at least four individual parts assembled together to form a singular brick or structure designed for engagement, cooperation, and compatibility with corresponding bricks, hubs, and construction-style bricks, such as LEGO branded bricks. These parts include a stud portion, a printed circuit board (PCB), a receptacle, and a cap portion. The stud portion of the brick forms the knobs of the brick and is comprised of a machined solid body cylinder, such as gold plated brass solid body tube, affixed to corresponding pad on the printed circuit board to provide an electrically conductive surface for engagement with corresponding conductive surfaces. The stud portion forming the knob extends upward from a flattened top portion a height of approximately 1.85 mm and has a diameter of approximately 4.88 mm. The horizontal pitch between the individual studs is approximately 7.986 mm.

In an alternate construction method, the stud portion forming the knob is comprised of a plastic material and preferably constructed through injection molding and integrated with electrical conductive materials. In this configuration, the stud includes a cap portion positioned on a top side of the individual knobs. The cap portion is comprised of a pressed tin-plated copper sheet including a copper tail portion that descends down the knob portion to an underside of the stud for engagement with a leg positioned below the knob. The tail portion is wrapped around the leg to mechanically secure the cap portion and tail portion. The structure of the stud and positioning of the leg is designed for conductive engagement with a corresponding pad on the printed circuit board (PCB).

The printed circuit board is positioned within the assembly and sandwiched between the stud portion and a receptacle portion in a conductive coupling. The printed circuit board has a top side and a bottom side and is generally configured for interconnecting the various electronic components of the device. The top side of the circuit board includes the connections for the knob portions of the studs for downlink communication positioned at an exterior of the printed circuit board and a plurality of central conductive pads positioned to receive a plurality of corresponding spring loaded pins. The bottom side of the printed circuit board includes uplink connectors positioned interior to the connections for the knob portions and are aligned with the receptacle portion.

The receptacle portion is sized and shaped for engagement with the printed circuit board and including a channel portion around a perimeter for receipt of the board. The receptacle portion including a plurality of cavities sized and shaped for engagement with corresponding knobs of a companion brick surrounding a central cavity. A conductive member, preferably a spring loaded pin (POGO pin) in conductive coupling with the bottom side of the printed circuit board is aligned within the cavities for removable conductive coupling with a corresponding conductive knob. Accordingly, the knob portions of corresponding brick members can be placed in removable conductive coupling within the receptacle portion for the varying electronic communications of the device. Preferably this spring loaded pin placed within the receptacle is of a low force variety exerting a force less than 30 grams, to ensure a suitable connection between a retained knob within a given receptacle cavity.

In an alternate construction method, a copper tape is in conductive coupling with the central cavity, the plurality of cavities, and the printed circuit board.

The cap portion of the assembly includes a top portion with corresponding apertures aligned and sized to receive the knobs of the stud portions and enclosing the internal components of the assembly. The cap portion is coupled to the receptacle in a secured coupling, wherein the cap portion secures the structure. The coupling may be secured through several fastening mechanisms, including but not limited to, a snap fit connection, an adhesive, or a removable fastener.

The above brick and hub structure can be configured with varying controls, protocols, programming standards, and structural elements for flexibility and variation in control and use. Accordingly, a brick assembly for wired conductivity can be placed in a 1×1 brick and wherein the brick can engage the IO pins on the hub. The 1×1 brick assembly including a cavity for receipt of a copper sheet in conductive engagement with a wire and in conductive communication with at least one stud portion of the brick. Further, a jumper brick is provided that includes a plurality of conductive studs and cavities in conductive coupling to propagate IO signals. Preferably, this jumper brick is provided in a 1×4 or 1×2 configuration.

Additional specialized bricks are provided in varying configurations to provide additional circuit functionality, controls, and features in the form of logic bricks, modification bricks, and peripheral bricks.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a top view of a grid layout for a standard twelve row by six column (12×6) hub brick, according to the present invention;

FIG. 2 is a top view of a grid layout for a standard (12×6) hub brick with downlink bricks engaged, according to the present invention;

FIG. 3 is an isometric view of a hub brick and a plurality of wire bricks engaged to the hub brick, according to the present invention;

FIG. 4 is an isometric view of a specialty brick, according to the present invention;

FIG. 5 is a top side exploded view of a specialty brick, according to the present invention;

FIG. 6 is a bottom exploded view of a specialty brick, according to the present invention;

FIG. 7 is an isometric view of the stud portion of the hub and brick assembly, according to the present invention;

FIG. 8 is a side view of the stud portion of the hub and brick assembly, according to the present invention;

FIG. 9 is an expanded view of an underside of the stud portion, according to the present invention;

FIG. 10 is an underside of a 2×2 receptacle, according to the present invention;

FIG. 11 is a top view of the 2×2 receptacle, according to the present invention;

FIG. 12 is an isometric view of the 2×2 receptacle, according to the present invention;

FIG. 13 is an exploded x-ray view of a 1×1 wire brick, according to the present invention;

FIG. 14 is an isometric view of a 2×2 debug brick and a 2×2 wire brick, according to the present invention;

FIG. 15 is a circuit board layout for an uplink, a downlink, and a debug connection, according to the present invention;

FIG. 16 is an exploded view of an embodiment of the 2×2 brick, according to the present invention;

FIG. 17 is an exploded x-ray view of a 4×1 jumper brick assembly, according to the present invention;

FIG. 18 is an isometric view of a Universal Serial Bus (USB) powered brick, according to the present invention;

FIG. 19 is an isometric view of a 12×6 hub brick, according to the present invention;

FIG. 20 is an exploded view of the 12×6 hub brick assembly, according to the present invention;

FIG. 21 is top view of the 12×6 hub brick assembly, according to the present invention;

FIG. 22 is an isometric view of a logic brick affixed to the 12×6 hub brick, according to the present invention;

FIG. 23 is an exploded x-ray view of a 2×1 logic brick with a cavity for the placement of an axial resistor, according to the present invention;

FIG. 24 is an isometric view of a rotational knob brick affixed to the 12×6 hub brick, according to the present invention;

FIG. 25 is an isometric view of a modification brick affixed to the 12×6 hub brick, according to the present invention; and

FIG. 26 is an isometric view of a circuit assembly engaged with a computing device, according to the present invention.

### DETAILED DESCRIPTION OF THE INVENTION

The following detailed description includes references to the accompanying drawing, which forms a part of the detailed description. The drawing shows, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

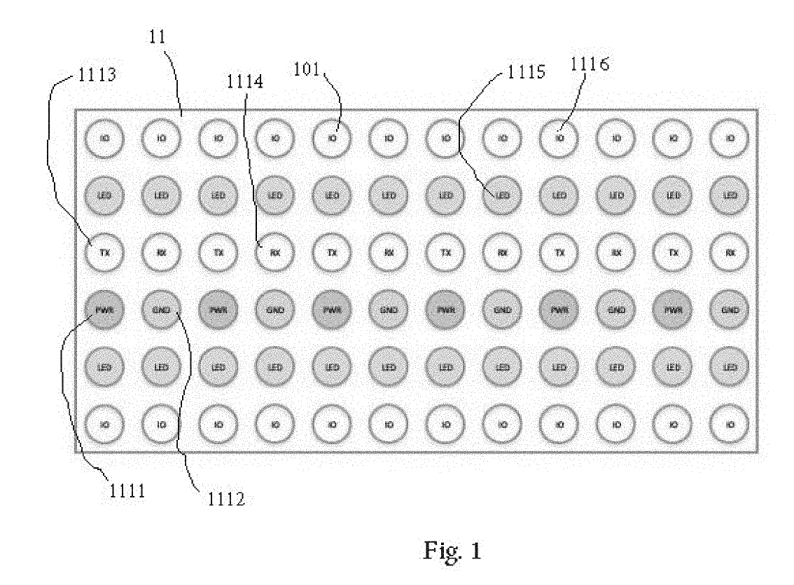

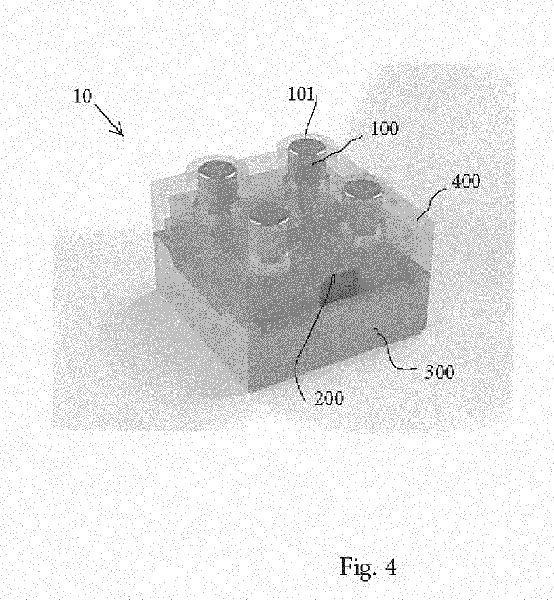

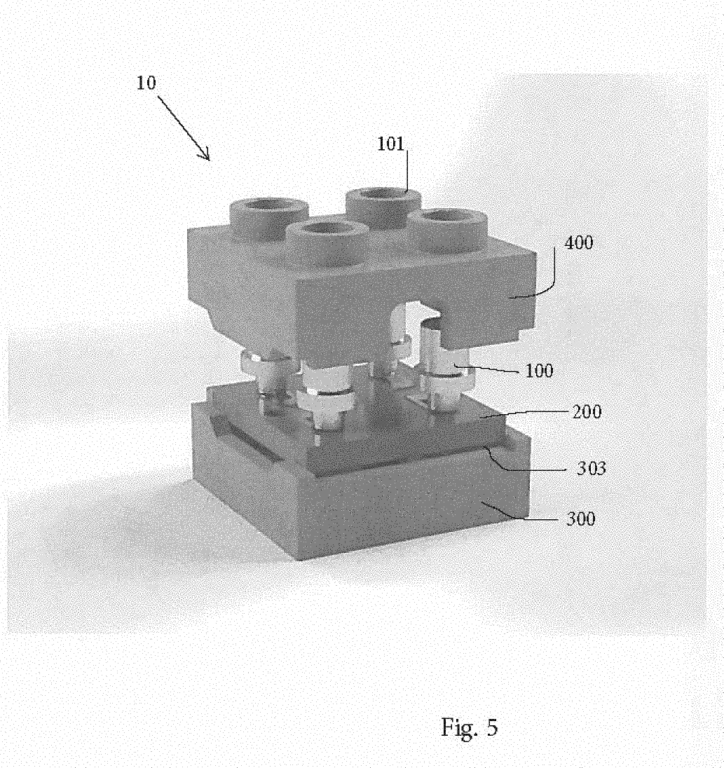

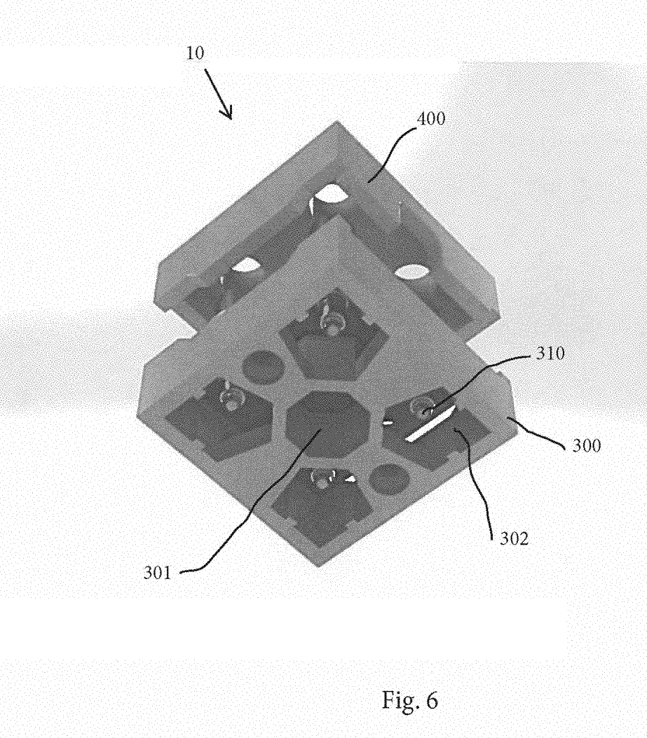

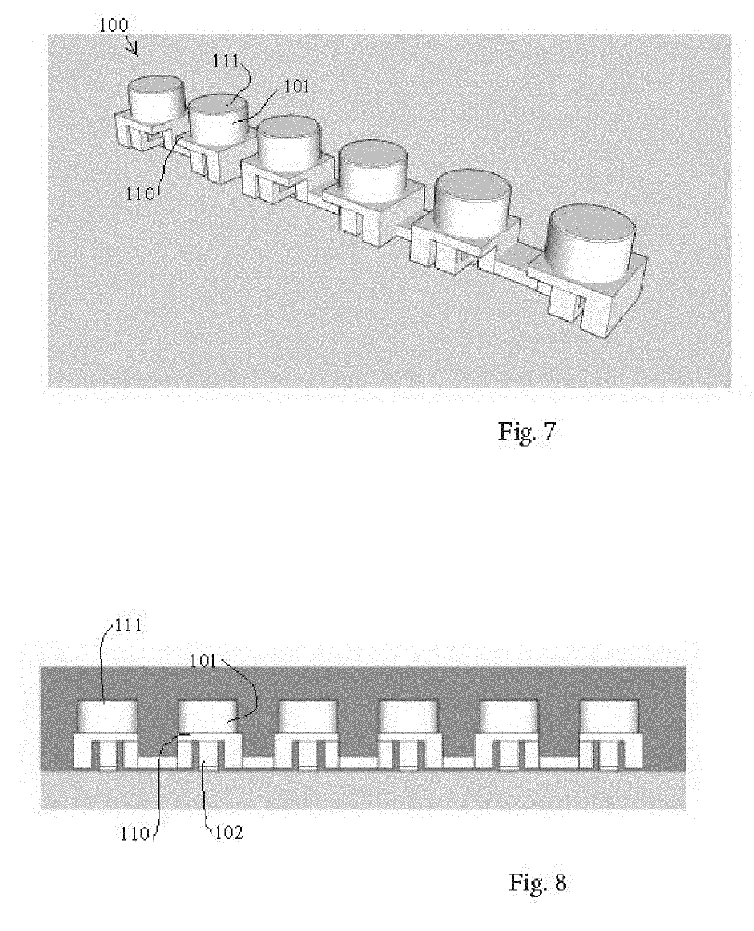

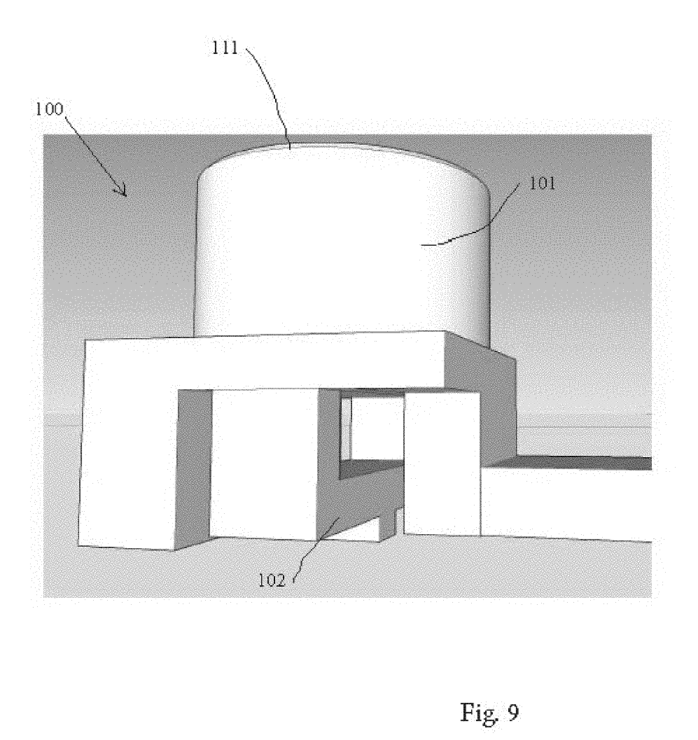

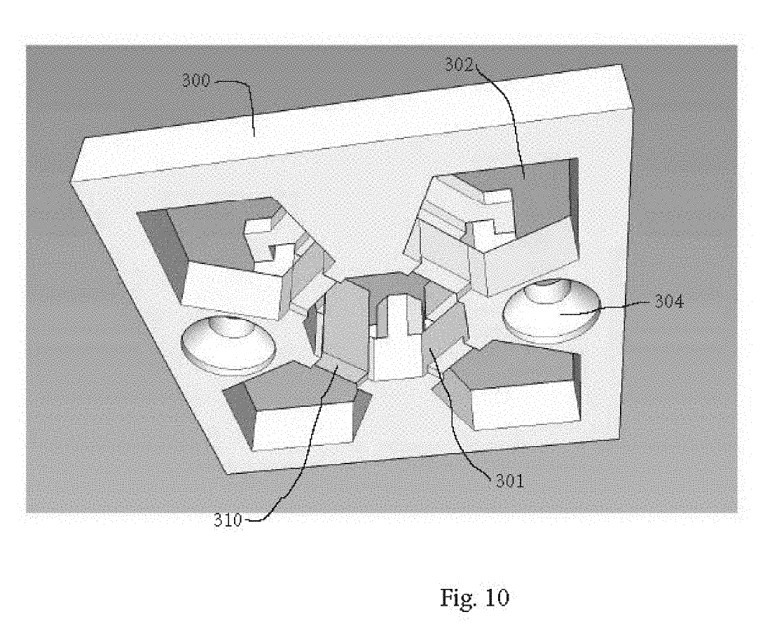

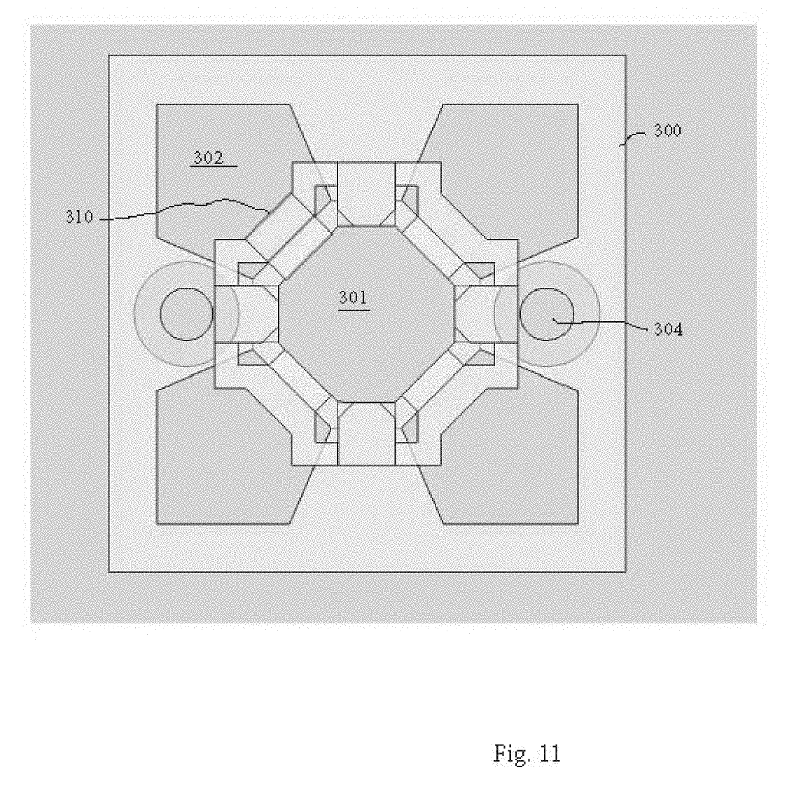

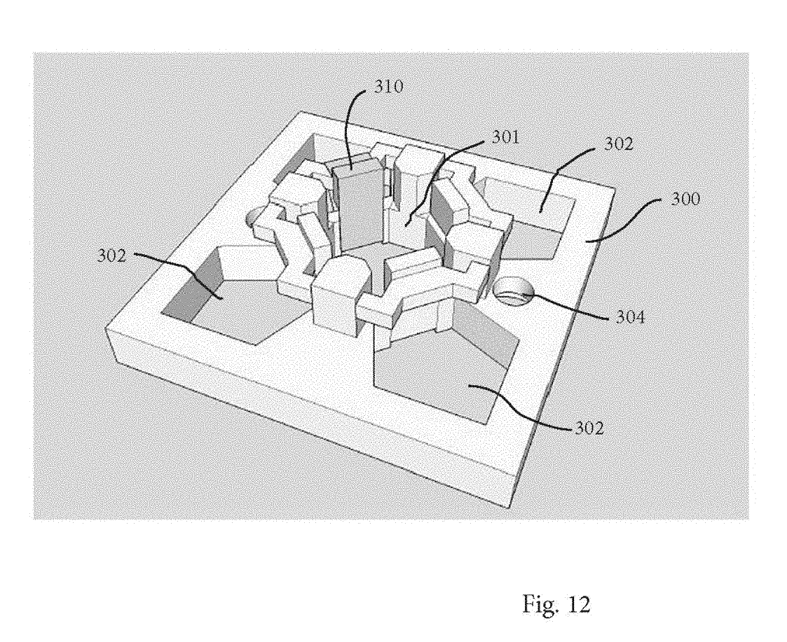

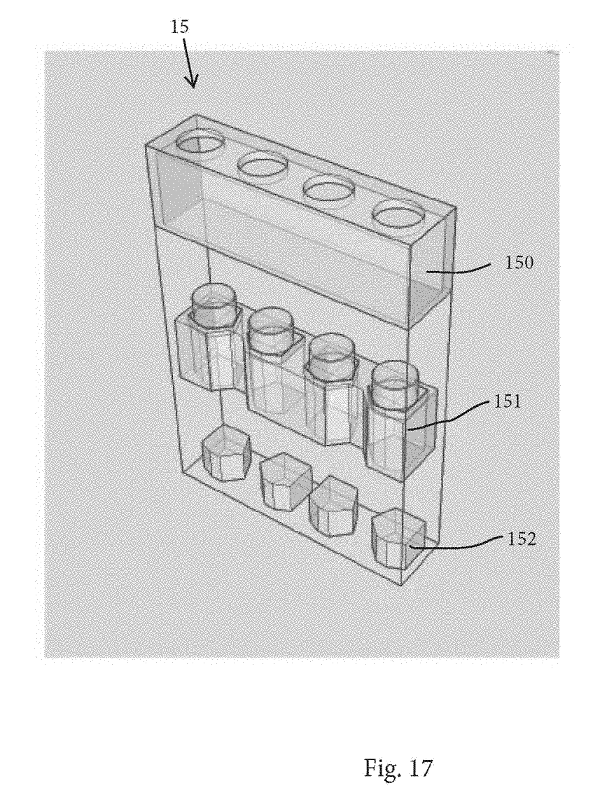

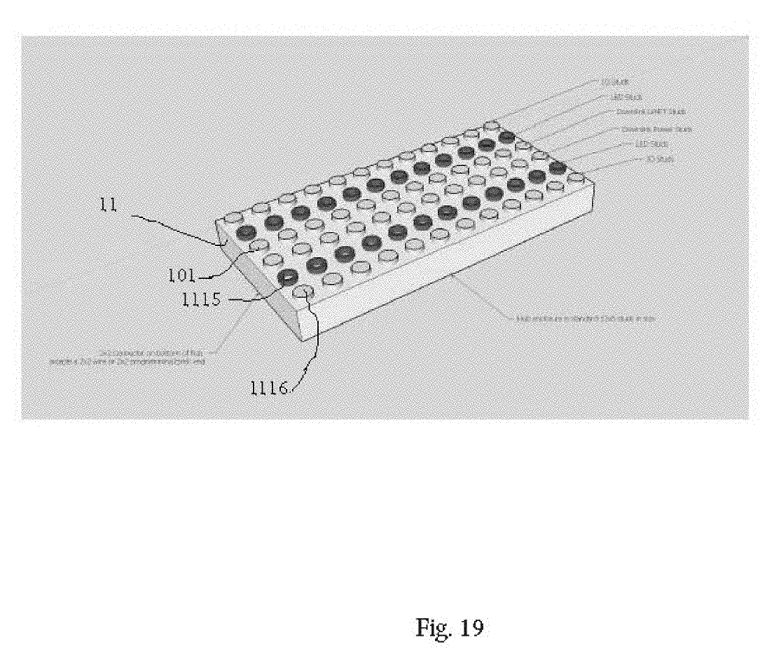

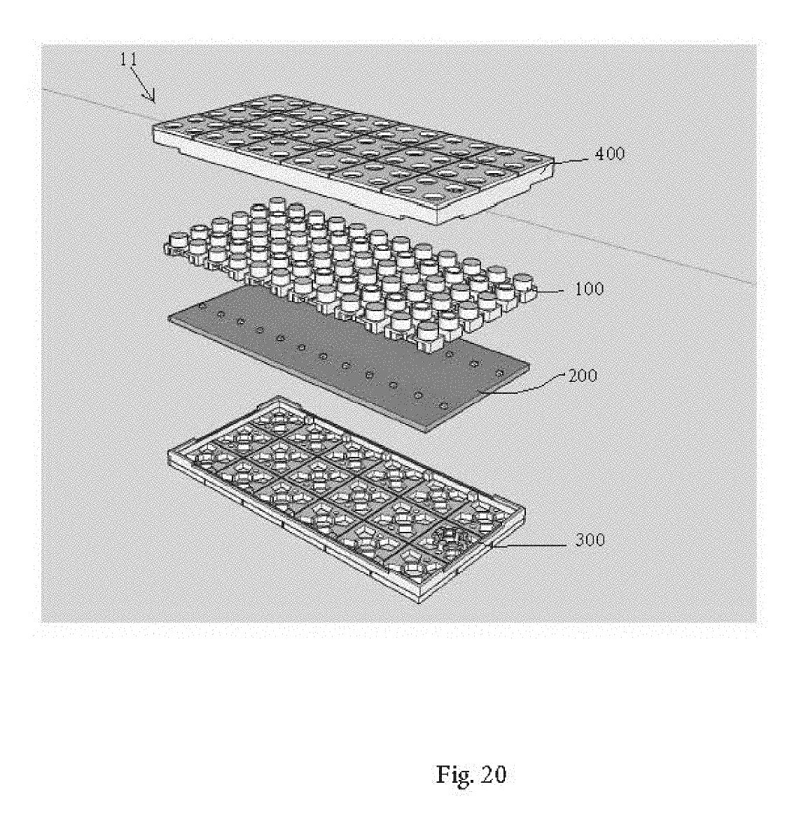

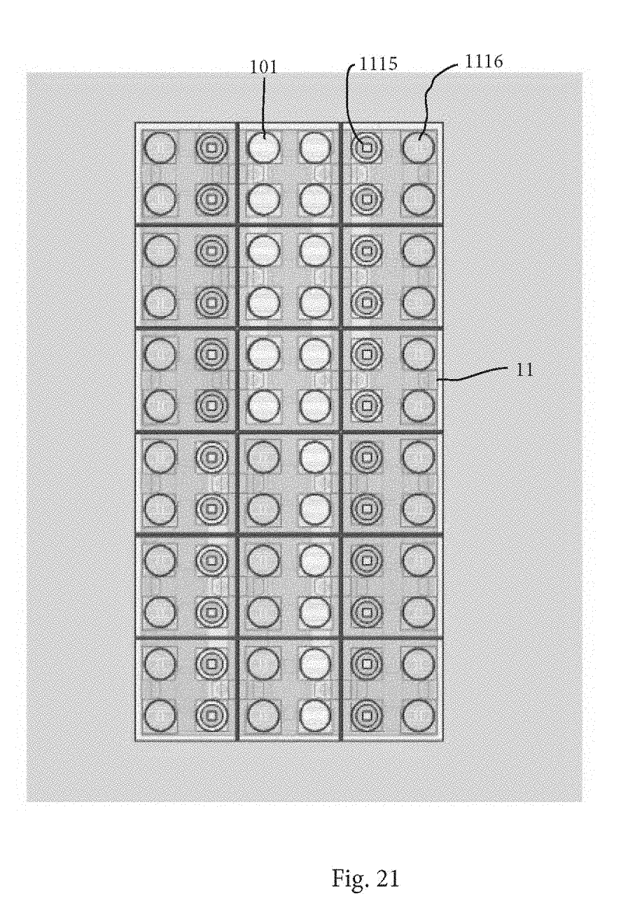

Referring now to FIG. 1-FIG. 26, of the simplified circuit building device and method of use according to the present invention. The circuit building device is comprised of many separate elements that in combination allow for the construction of a simplified circuit building device though an assembly mechanism resembling a construction brick style assembly having a hollow cavity inner portion with a centralized inner tube and cylindrically shaped raised knobs arranged in horizontal rows and vertical columns on a top side of the building brick. Accordingly, several components of the device are sized, shaped, and configured for attachment to standard construction bricks 1, such as LEGO branded bricks.

The device of the present invention utilizes a plurality of various types of specialized bricks 10 having internal components allowing for conductive coupling between each other. The various bricks 10 of the present invention are generally assembled from individual components coupled together and comprised of at least four individual parts assembled together to form a singular brick or structure designed for engagement, cooperation, and compatibility with corresponding specialized bricks and construction-style bricks 1, such as LEGO branded building blocks. These parts include a stud portion 100, a printed circuit board 200, a receptacle 300, and a cap portion 400. The stud portion 100 of the brick forms at least a portion of one knob 101 of the brick 10 and is comprised of a electrically conductive machined metallic solid body cylinder shaped member 100 and surrounded by the cap portion 400 to form individual knobs 101. Typically, a brick 10 of the present invention includes a plurality of knobs 101 arranged in horizontal and vertical columns. The stud portion 100 individual knobs 101 extend upward from a flattened top portion 110 a height of approximately 1.85 mm and have a diameter of approximately 4.88 mm. The horizontal pitch between the individual knobs 101 is approximately 7.986 mm. The conductive structure of the stud 100 is designed for conductive engagement with a corresponding first conductive pad 210 on the printed circuit board (PCB) 200, wherein the stud 100 is affixed directly to the PCB 200.

In an alternate configuration, the stud portion 100 is constructed out of a plastic material, preferably though injection molding, with an integrated conductive cap portion 111 positioned on the individual knobs 101. The cap portion 111 is comprised of a pressed tin-plated copper sheet including a copper tail portion that descends down the knob portion 101 to an underside of the stud 100 for engagement with a leg 102 positioned below the knob 101. The tail portion is wrapped around the leg 102 to mechanically secure the cap portion 111 and tail portion. The structure of the stud 101 and positioning of the leg 102 is designed for conductive engagement with the corresponding first conductive pad 210 on the printed circuit board (PCB) 200.

The printed circuit board 200 is positioned within the assembly and sandwiched between the cap portion 400 and the receptacle portion 300 in a conductive coupling with the stud portion 100 and receptacle portion 300. The printed circuit board 200 has a top side 201 and a bottom side 202 and is generally configured for interconnecting the various electronic components of the bricks 10. The top side 201 of the circuit board 200 includes the connection in the form of a first conductive pad 210 coupled to the knob portions 101 of the studs 100 for a downlink communication at an exterior of the printed circuit board 200. In a typical two row by two column (2×2) brick 10 of the assembly of the present invention, the top side 201 includes four first conductive pads 210 positioned adjacent the perimeter of the circuit board 200 and aligned with each knob 101 of the brick 10, wherein each knob 101 is engaged with a conductive pad 210.

The top side 201 of the printed circuit board 200 further includes a plurality of second conductive pads 211 centrally positioned on the circuit board 200 and positioned to receive a plurality of corresponding spring loaded pins 2111. The spring loaded pins 2111 allowing for coupling with the circuit board 200 and providing a link for the input of various programming languages.

The bottom side 202 of the printed circuit board 200 includes a third conductive pad 220 positioned for conductive coupling with items placed within the receptacle portion 300 of the device. The third conductive pad 220 provides an uplink connector and is positioned interior to the first conductive pad 210 for coupled communication with the various additional connections of the circuit board 200.

The receptacle portion 300 is sized and shaped for engagement with the printed circuit board 200 and including a channel portion 303 around a perimeter of the receptacle for receipt of the circuit board 200. The receptacle portion 300 including a plurality of cavities 302 sized and shaped for engagement with corresponding knobs 101 of a companion brick 10 surrounding a central cavity 301. A conductive member 310, preferably in the form of a spring loaded pin directly soldered to the board 200 at the third conductive pad 220, is in conductive coupling with the plurality of cavities 302. Accordingly, the knob portions 101 of corresponding brick members 10 can be placed in removable conductive coupling within the receptacle portion 300 for engagement with the conductive member 310 for the varying electronic communications of the device. Preferably this spring loaded pin conductive member 310 placed within the receptacle 300 is a low force spring loaded pin, preferably within a range of between 20 grams to 30 grams and least less than 30 grams of spring force exerted during engagement, to ensure a suitable connection between a retained knob 101 within a given receptacle cavity 302.

The cap portion 400 of the assembly includes a top portion 401 with corresponding apertures 410 aligned and sized to receive the knobs 101 of the stud portions 100 and enclosing the internal components of the assembly. The top portion 401 may additionally include a plurality of central apertures 411 aligned to receive the pins 2111 of a specialized brick assembly. The cap portion 400 is coupled to the receptacle in a secured coupling, wherein the cap portion 400 secures the structure of the brick 10. The coupling may be secured through several fastening mechanisms, including but not limited to, a snap fit connection, an adhesive, or a removable fastener. When a removable fastener is used, the receptacle 300 may include a fastener aperture 304, wherein the removable fastener may be utilized to provide for a removal and replacement of the printed circuit board 200.

One such specialized brick 10 of the present invention is a main hub brick 11. The main hub brick 11 of the present invention has a functional resemblance to a solderless breadboard and is configured with a physical enclosure resembling a large construction-style building block, such as a LEGO branded brick. This enclosure shape allows a user to assemble a circuit in a similar manner to how a user would assemble a construction style building block assembly, wherein individual bricks are snapped together in an adjacent coupling.

Accordingly, the main hub brick 11 of the present invention is sized and shaped to resemble a rectangular construction-style building brick, as is commonly known in the prior art. The main hub brick 11 is comprised of stud portion 100, circuit board 200, receptacle 300, and cap portion 400 and designed to engage specialty bricks 10 to allow for the coupling of a direct current (DC) power source and Universal Asynchronous Receiver/Transmitter (UART) connection to the main hub brick 11 various specialty bricks 10 providing additional structural elements to distribute this power and data with a number of hubs or peripherals, referred to as the “downlinks,” and positioned on the raised knobs 101 of the main hub brick 11.

The main hub brick 11 is comprised of six (6) horizontal rows of knobs 101 and a fixed number of columns of knobs 101 in a 6× N configuration. The central two rows of these horizontal rows of knobs 101 are dedicated as downlinks in a two by two (2×2) pattern with the opposed pairs comprised of a powered knob 1111, a ground knob 1112, a transmission knob 1113, and a receiving knob 1114. These downlinks include circuitry for performing Analog to Digital Converter (ADC) measurements. The ability to perform measurements is essential to simplifying and lowering system cost, as some of the specialized bricks 10 placed upon the downlinks are merely bricks with a pair of resistors. The main hub brick 11 can detect these combinations and use this to emulate part of the circuit under its control. Additionally, the ADC measurements allow for the placement of specialized bricks that utilize only analog elements, such as, but not limited to, resistors, capacitors, diodes, and inductors, for use in specialized knob and pushbutton-style bricks utilizing only these analog elements.

The exterior two (2) horizontal rows of the main hub brick 11 are preferably comprised of a light emitting diode (LED) 1115 positioned inner the exterior row and adjacent to the central rows and input/output (IO) pins 1116 on the exterior row and adjacent to the LED 1115.

When the specialized bricks 10 are placed on the downlink pairs 1111-1114 of the main hub brick 11, the associated LED 1115 and IO 1116 columns aligned with the specialized brick 10 become dedicated to that particular specialized brick 10. Accordingly, the hub brick 11 can be assembled with alternate components and configurations wherein additional items are added or removed to improve function and reduce costs. One such configuration is to provide the main hub brick 11 without LEDS and wherein the hub only includes IO knobs exterior to the central two rows. Within this configuration, all communication would occur on the uplink/downlink connection. Some specialty bricks 10 would not be applicable to this type of hub configuration as the logic for the circuit would need to be programmed into the hub microcontroller or by a host computer 1. Further, a main hub brick 11 can be provided without IO knobs or LEDs and simply be utilized to propagate power. Further, the ADC circuitry may be removed for added simplicity and conversely eliminating the ability of the main hub brick 11 to detect passive bricks.

As the main hub brick 11 can accept a number of orientations on the downlink knobs 1111-1114, polarization can be utilized to ensure that the orientation of attached bricks is acceptable to the circuit. Accordingly, passive brick orientation should always be the same for resistor measurement to work. Additionally, for active bricks that accept power, polarization is useful to ensure that power is always provided on the bottom and within the receptacle portion 300. Likewise, physical polarization in the form of physical indentations on the downlink row of the main hub brick 11 and wherein the parts assigned for downlink connection include a corresponding protrusion for receipt within the indentation. These physical features of meshed indentations and protrusions would allow a user freedom to place a downlink brick on any column of the hub as long as the row is on the power row and facing the proper direction.

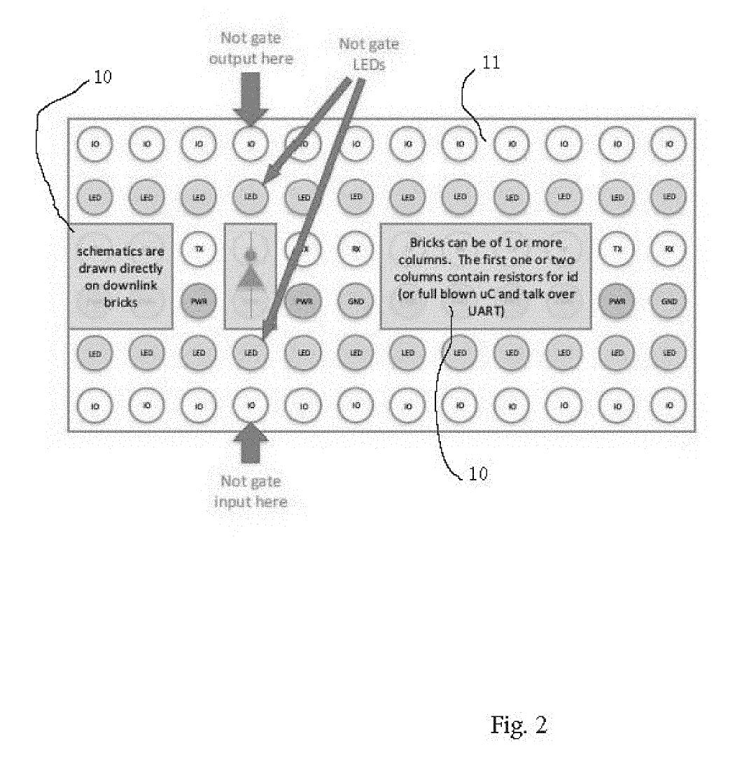

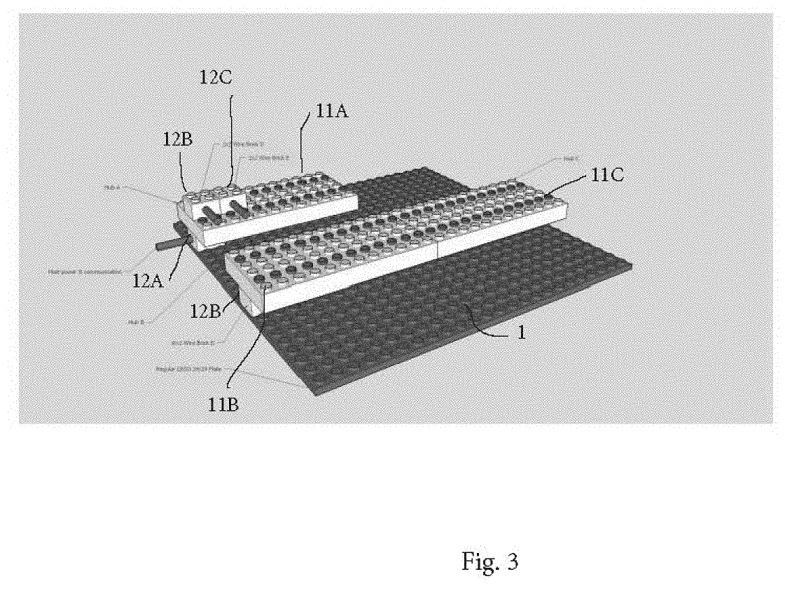

Referring to FIGS. 2-3, the hub brick 11 can be connected to a standard construction block 1, such as a LEGO branded 24×24 plate, and wherein multiple main hub bricks 11 can be configured to allow for expansion and growth of a circuit assembly. Communication between main hub bricks 11 is effectuated through connection between specialized brick 10 types provided in a wire brick 12. Within FIG. 3, a first wire brick 12A is shown paired to the uplink third conducting pad 220 of a first main hub brick 11A to provide power and communication to the first main hub brick 11A through engagement with the receptacle portion 300. The power and communication of the first wire brick 12A is distributed to a second main hub brick 11B through a second wire brick 12B coupled to the 1^{st} and 2^{nd} downlink knobs of the first main hub brick 11A and secured to the uplink of the second main hub brick 11B, wherein the second wire brick 12B is comprised of a pair of ends in wired communication. A third wired brick 12C propagates the power and communication of the first wire brick 12A to a third main hub brick 11C through a third wire brick 12C coupled to the 3^{rd} and 4^{th} downlink knobs of the first main hub brick 11A and secured to the uplink of the third main hub brick 11C, wherein the third wire brick 12C is comprised of a pair of ends in wired communication.

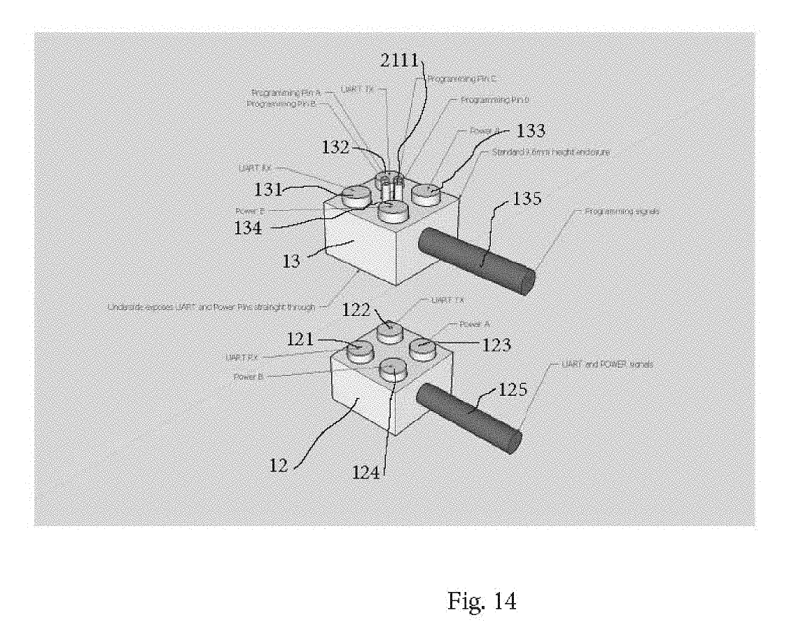

Referring now to FIG. 14, the specialized wire brick 12 is shown in greater detail and wherein the wire brick 12 is a 2×2 brick having electronic components to extend power and communication during circuit assembly. The wire brick 12 is comprised of a pair of ends in wired communication through a wire 125 and wherein each end of the pair of wired ends include a UART receiving knob 121, a UART transmission knob 122, a first power knob 123, and a second power knob 124.

Another such specialized brick 10 is a debug brick 13. The debug brick 13 is a 2×2 brick having electronic components to extend power and communication during circuit assembly and provide a connection to a pin enables debug interface within the debug brick 13. The debug brick 13 top side includes a receiving knob 131, a transmission knob 132, a first power knob 133, a second power knob 134, and a plurality of at least two spring loaded pins 2111 for the transmission of on chip instrumentation to the PCB, including but not limited to, JTAG, ARM's serial wire debug connector, and TI's Spy-by wire. Preferably, the receiving knob 131 and transmission knob 132 utilize UART as the preferred communication protocol, but other serial protocols may be utilized. Preferably the debug brick 13 includes up to four spring loaded pins 2111 to allow for the transmission of a signal for on chip instrumentation. The debug brick 13 includes a wire 135 for the transmission of the signals from the debug brick 13 and wherein the wire can transmit up to eight (8) different signals to allow for the transmission of power, debugging signals, and communication. The debug brick 13 would preferably be connected to a specialized PCB that would include additional debug headers and to connect to industry standard debugging connectors.

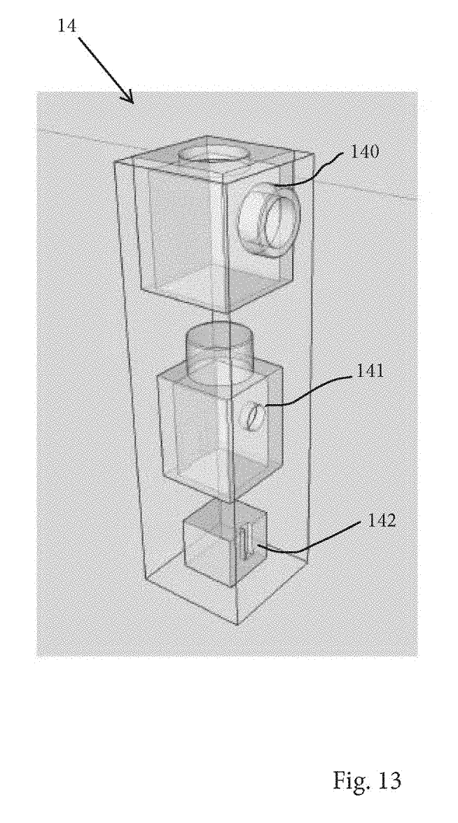

In addition to the specialized wire brick 12 and debug brick 13, a single wire brick 14 (FIG. 13) is provided to connect the IO knob pin 1116 on the main hub brick 11. The single wire brick 14 is generally comprised of three portions in conductive coupling to couple IO signals. A cap portion 140 surrounds a central stud portion 141 with a cavity for the placement of a conductive member 142, wherein the assembly forms a continuous conductive path for transmission from the inner cavity conductive member 142 to the central stud portion 141. Accordingly, the assembly of the single wire brick may include various copper sheets, taps, and wires. The central stud portion 141 is assembled similar to the knob 101 cap portion 111, wherein the central stud portion 141 has the same size, shape, and configuration as the knob 101. The single wire brick 14 may be assembled in a piggybacked series and preferably utilizes a 28 gauge standard wire. Alternately, the single wire brick 14 may not include a conductive knob at a top side.

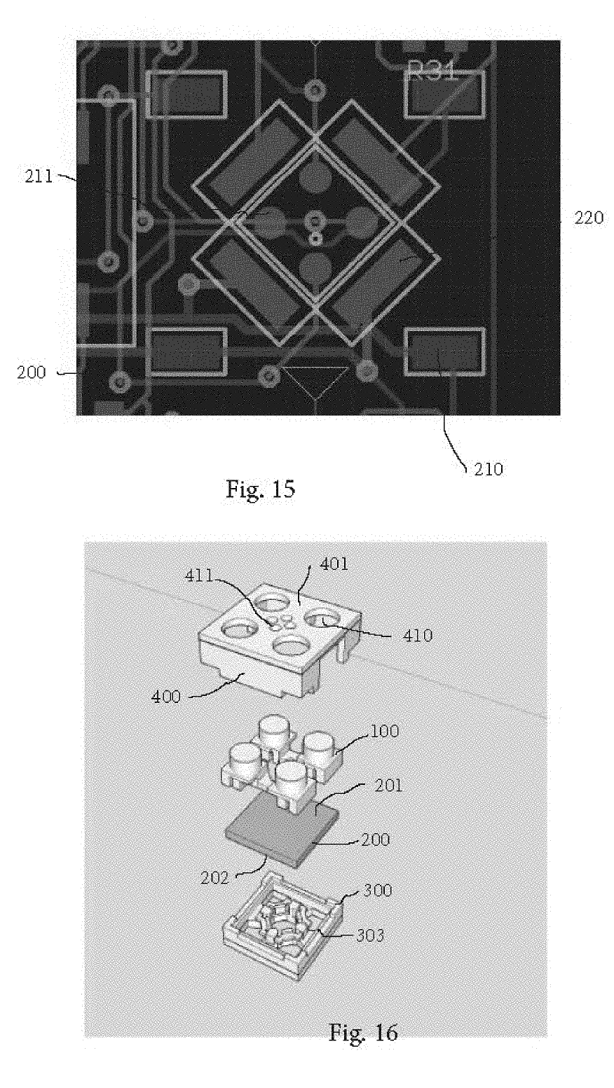

An additional IO propagation specialized brick 10 is a jumper brick 15 (FIG. 15). Similar to the single wire brick 14, the jumper brick 15 is a specialized brick 10 assembly having conductive coupling between a stud portion and receptacle portion and provided in a 1×2 or 1×4 size and is similar to the specialty brick 10 assembly without the inclusion of the printed circuit board 200. Accordingly, the jumper brick 15 includes a cap portion 150, stud portion 151, and receptacle portion 152. The stud portion 151 forming a knob in conductive communication with the receptacle portion 152. Preferably the conductive coupling utilizes copper metal caps on the knob portion and copper tape within the receptacle 152. Alternately, the jumper brick 15 could be assembled with only a conductive portion within the receptacle 152 or only on the stud portion 151 knob.

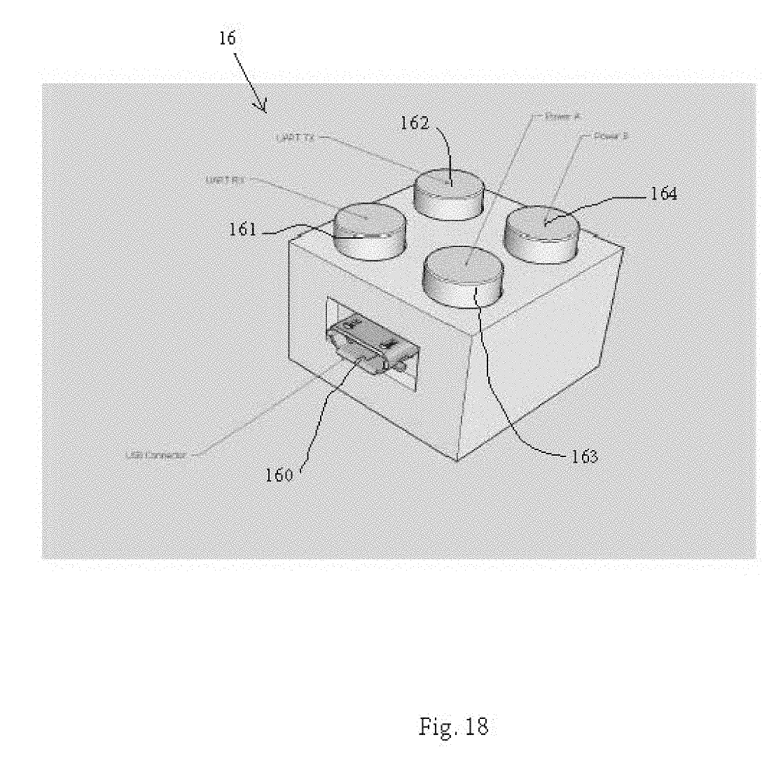

Referring now to FIG. 18, a specialty power brick 16 is shown. The power brick 16 is generally configured to as the starting point for powering the circuit and attached peripherals downstream from the power brick 16. The power brick 16 is sized and shaped to engage with the main hub brick 11 and includes knobs on a top side and including a UART receiving knob 161, a UART transmission knob 162, a first power knob 163, and a second power knob 164. The power brick 16 includes a power connector 160 for providing power to the power brick 16 from an external power source. Preferably, this connector 160 is a USB connector type allowing for both data and power transmission. Alternately, the power brick 16 can be configured to receive a Bluetooth connection or include an internal power source, in the form of a battery.

In use, the power brick 16 is electrically isolated from downstream power to prevent short circuits from powering down the power brick 16. Further, the power brick 16 has the capability to monitor current and voltage and includes electronic components to handle supervisory roles within the circuit construction. Preferably, the power brick 16 includes capabilities for connection and communication between a host computer 3 to add, edit, review, analyze, or otherwise interact with a constructed circuit.

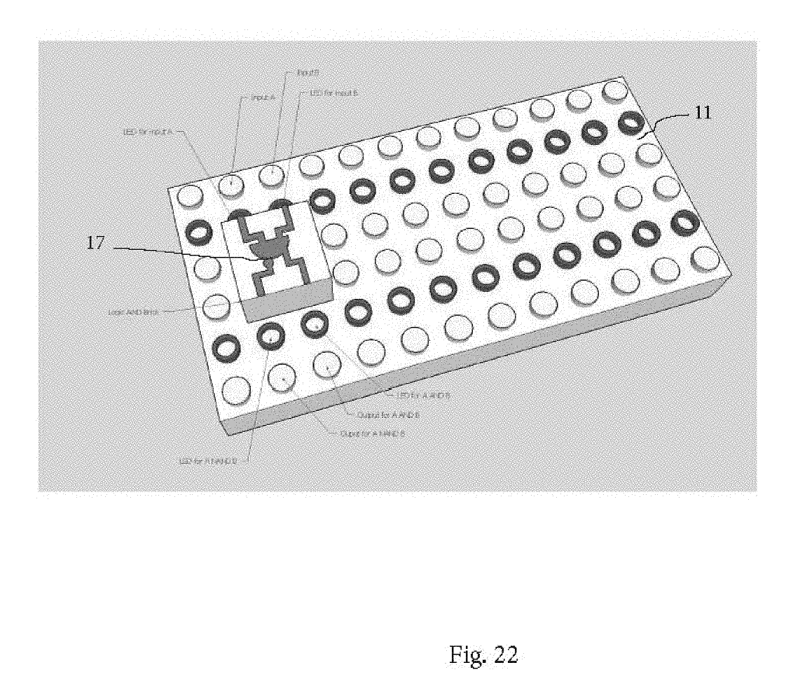

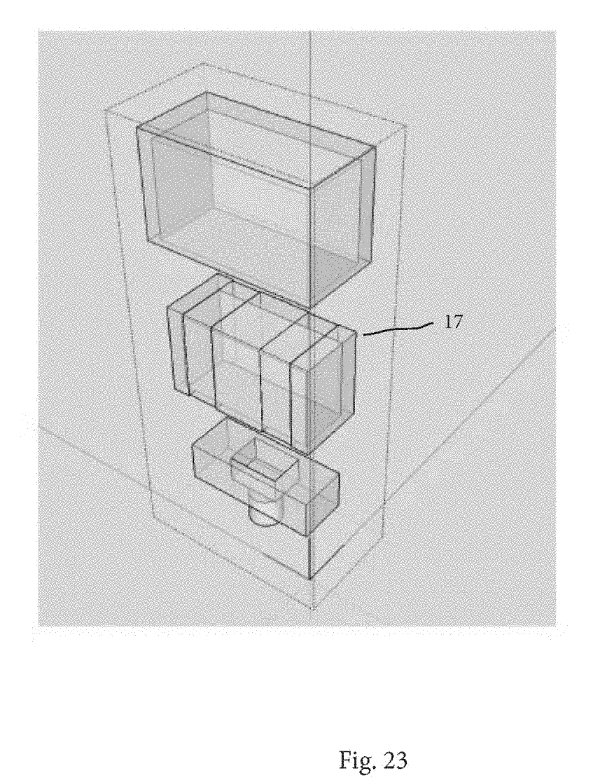

Referring now to FIG. 22, another such specialty brick of the present invention is a logic brick 17. The logic brick 17 is placed on the downlink knobs 1111-114 of the main hub brick 11 to indicate a logical function that is to be emulated. The logic brick 17 themselves only contains circuitry to allow the main hub brick 11 to detect its identifier. The logic brick 17 are always provided in a configuration that is at least two rows tall and can be any number of rows wide. The logic brick 17 includes receptacles 171 for the receipt of the knobs 1111-1114. In a 2×1 logic brick 17 (FIG. 18) both of the receptacles 171 for engagement with the knobs of the main hub brick 11 are conductive and contain a single precision resistor for identification. For 2×2 and 2×N logic bricks 17 the first four receptacles 171 for engagement with the knobs of the main hub brick 11 are conductive and short column wise with two independent precision resistors. The main hub brick 11 communicative properties are utilized to determine the type of logic brick 17 placed upon it, utilize identification codes, and determine the physical size of the logic brick 17 and the function to emulate.

For each column on the main hub brick 11 occupied by the logic brick 17 there is a corresponding LED and IO knob above and below it, as logic bricks 17 are only received on the central two rows, that will follow the particular knob on the emulated logic function. Accordingly, different types of the logic bricks 17 will have a different effect on the LED and IO associated with it. For example, a logic brick 17 having the type of a “Not gate” would have an input knob on one side of the logic brick 17 as it is placed on the main hub brick 11 and an output knob on an opposed second side of the logic brick 17. Accordingly, a high signal from the first side IO knob of the hub brick 11 would turn on the associated first side LED, which would turn off the second side LED and set the second side IO knob to low. In the preferred embodiment of the present invention, the logic bricks 17 are active low logic and allow for floating inputs that will always be pulled down. This configuration reduces the number of wires needed within the brick 17 and keeps the design and usage of the circuit as simple as possible. The logic bricks 17 of the present invention can be both combinatorial and sequential. Additionally, various types of logic bricks 17 can be utilized, but not limited to, the functions and features shown in the below TABLE I of logic brick 17 types.

TABLE I

| Brick | Columns | Notes |
|---|---|---|
| ON/OFF | 1 | ON for one pin, OFF for other |
| Buffer | 1 | Buffers one pin down to the other |
| NOT | 1 | Logical not operation |
| AND | 2 | Takes two inputs and produces a logical |
| | | AND operation |
| OR | 2 | Takes two inputs and produces a logical |
| | | OR operation |
| XOR | 2 | Takes two inputs and produces a logical |
| | | XOR operation |
| Mux | 4 | Takes 4 inputs and 2 selectors and passes |
| | | the input to the output |
| Demur | 4 | Takes 1 input and 2 selectors and passes |
| | | the input to one of the 4 outputs |
| Decoder | | |
| Full adder | 3 | Takes thee inputs, sums them and returns the |
| | | result plus overflow bit |
| Clock | 1 | Runs a clock at a fixed rate |
| SR Latch | 2 | |
| JK Flip-flop | 2 | |
| D Flip-flop | 3 | |
| Shift register | 4 | |
| Counter | 4 | |
| Logic Analyzer | 4 | Allows the software to watch a series of |
| | | IO pins and draw them onscreen like a logic |
| | | analyzer. Function generator would be just |
| | | the opposite. |

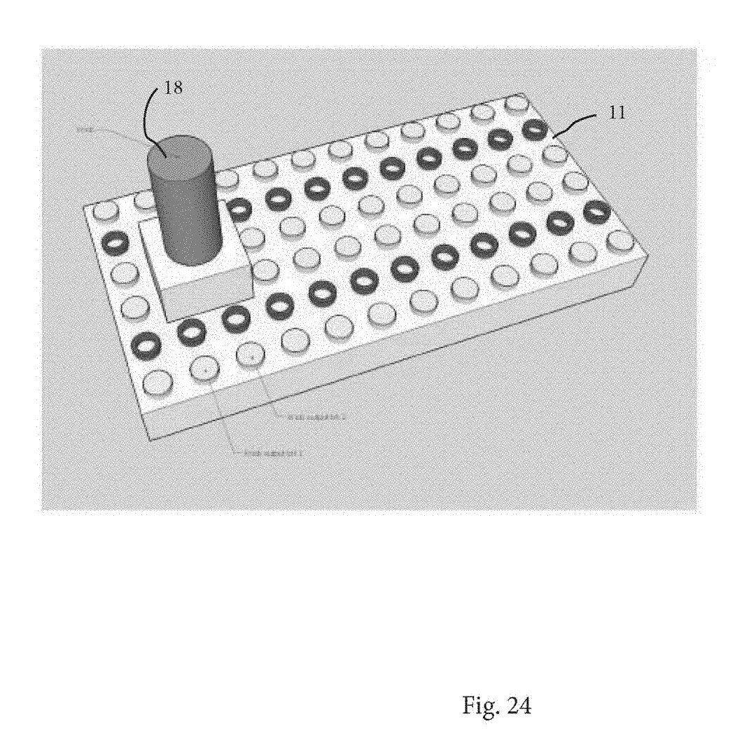

Referring now to FIG. 24, a specialty peripheral brick 18 is shown in the form of a rotational knob. Peripheral bricks 18 extend the capabilities of the circuit construction by adding an additional input or output to the brick itself, unlike the logic bricks 17 which are completely emulated on the hub 11. Peripheral bricks 18 will always occupy at least two columns and use all four of the knobs 1111-1114 to aid in hub identification and communication.

Peripheral bricks 18 can be both passive or powered. Passive peripheral bricks 18 only contain passive components (LRC type circuits) with a current value that requires the use of the hub 11 ADCs. Passive peripheral bricks 18 allow for simpler circuits and a far lower cost as they do not require a microcontroller to power and protect them. Some passive peripheral bricks 18 include, but are not limited to, buttons, switches, rotational knobs, and light detectors (photo resistors). Powered peripheral bricks 18 use an embedded microcontroller to communicate with the hub via UART. This microcontroller will communicate the type of peripheral brick 18 and direct how the hub 11 should host the LED and IO pins on its behalf. Some powered peripheral bricks 18, include, but are not limited to, seven segment displays, buzzers, and additional hubs. Additional hubs 11, when considered a specialized powered peripheral brick 18 add to the modularity of the overall design and usage of the system. Additionally, various types of peripheral bricks 18 can be utilized, but not limited to, the functions and features shown in the below TABLE II of peripheral brick 18 types.

TABLE II

| Brick | Columns | Notes |
|---|---|---|
| Button | 2 | Normally off, depress to turn on |
| Toggle Switch | 2 | Toggle switch, turns on for the side |
| | | in which the switch is on |
| DIP Switch | 2 | DIP switch, turns on for the side |
| | | in which the switch is on |
| Knob | 2 | Binary encoded value |
| Large LED | 2 | Just one really bright LED in the |
| | | center of 4 studs |
| 7 Segment | 4 | Displays any number from 00 to 99 |
| Display | | |
| Speaker | 4 | Plays a tone |

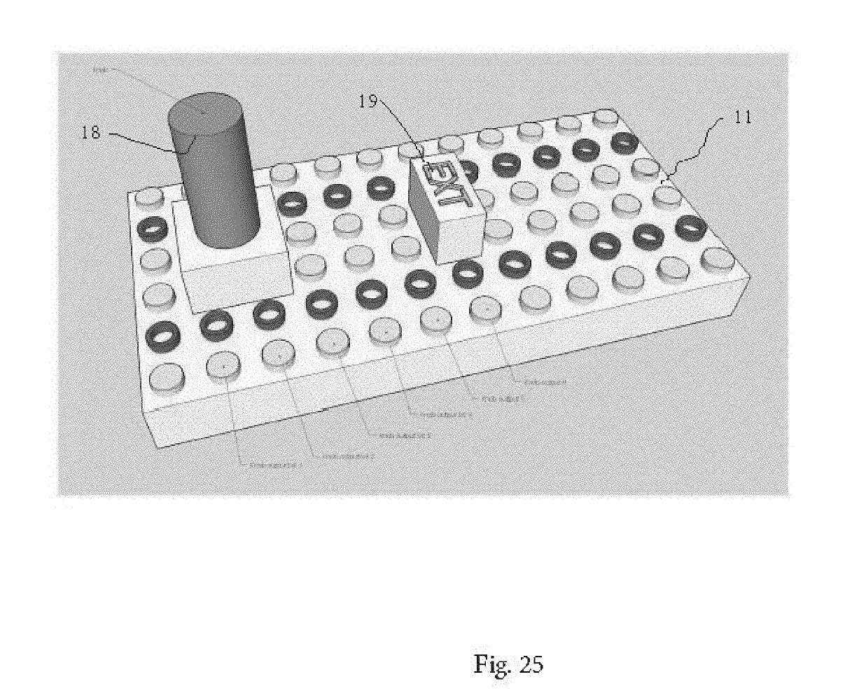

Referring now to FIG. 25, a special modification brick 19 in the form of an extender is shown. Special modification bricks 19, or mod bricks, when placed in series on downlink rows can be sequenced to create different types of interpretations. For example, a 2×1 reset mod brick 19 could be added before a 2×2 counter logic brick 17, wherein the reset adds additional functionality not present on the counter logic brick 17. Another example would be to add a 2×1 extender logic brick to the end of the 2×2 counter brick. This would extend the number of bits of the counter brick. Further, a gap between bricks can be utilized where the counter brick could be extended at least six (6) bits depending upon where the extender brick 19 is placed.

The modification bricks 19 allow for expressivity in circuit design and can be provided in multiple variations to modify the hub 11 in other practical ways. Additionally, various types of mod bricks 19 can be utilized, but not limited to, the functions and features shown in the below TABLE III of modification brick 19 and TABLE IV of extender mode brick effects.

TABLE III

| Brick | Notes |
|---|---|
| Power/Reset | Adds power enable and reset pins to any brick. |
| | This could extend to a hub (and all bricks on it) |
| | by placing before the 2 × 2 Wire Brick that |
| | will connect to the |
| Extender | Extends the length of the bricks inputs or |
| | outputs (or both). Actual function depends on |
| | the logic brick or peripheral being extended |
| | (see below). |
| Red Colorizer | Makes all LEDs effected red |
| Green Colorizer | Makes all LEDs effected green |
| Blue Colorizer | Makes all LEDs effected blue |
| Stop Colorizer | Stops most inner colorizer |
| Close bracket | Stops modification for a range |
| PWM In | Takes the primary input as a PWM |
| PWM Out | Takes the primary output as a PWM |
| Option A | Configures the brick with extra options |
| Option B | Configures the brick with extra options |

TABLE IV

| Brick | Notes |
|---|---|
| ON/OFF | Will extend the High or Low signal |
| | to the extender brick |
| Buffer | Creates multiple isolated buffer columns |
| NOT | Creates multiple isolated NOT operations |
| | (one per column) |
| AND | Creates a N-input, 1 output AND where N |
| | is the total of columns after extension |
| OR | Creates a N-input OR gate where N is the |
| | total number of columns after |
| XOR | Nothing |
| MUX | Creates a N-input Multiplexor. The selector |
| | extends by log2(N). The output is always |
| | rightmost bottom |
| DEMUX | Creates a N-output Demultiplexer |
| Full adder | Nothing |
| Clock | Divides by 10 the clock output for each |
| | column extended |
| Latches, | Nothing |
| flip-flops | |
| Shift register | Creates an N-bit shift register |
| Counter | Creates an N-bit counter |
| Logic Analyzer | Creates an N-bit logic analyzer |
| Button | Extends the button value |
| Toggle switch | Extends the switch value |
| Analog input | Extends the output bit representation |
| peripherals (i.e. | |
| knob, light sensor, | |
| audio sensor) | |
| Other peripherals | Nothing |

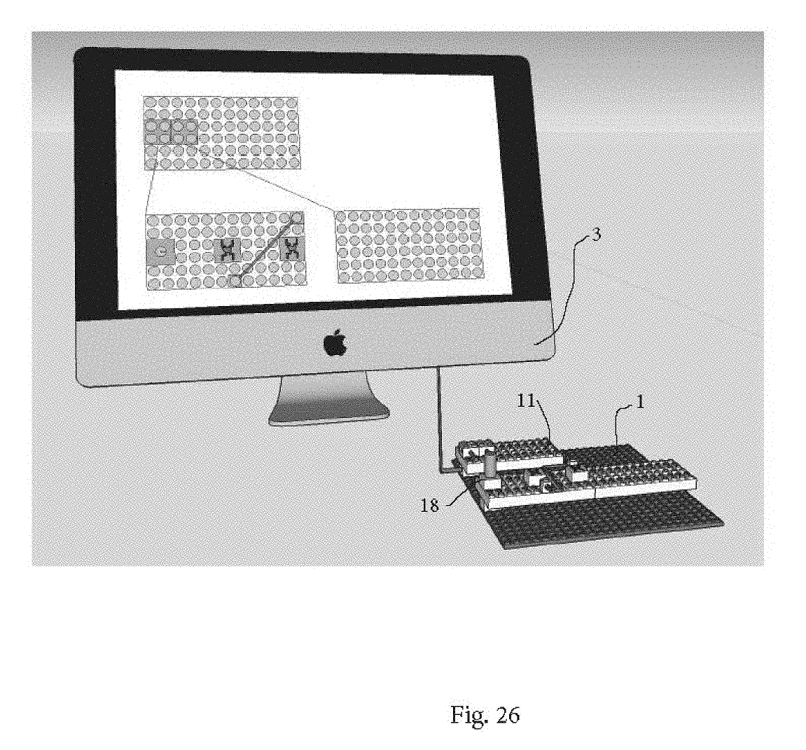

Referring now to FIG. 26, a circuit assembly of several bricks of the present invention in communication with a host computer 3. The various circuit assemblies of the device of the present invention can be utilized without a connection to a host computer 3, but when connected to a host computer 3 additional possible uses and features are provided. The computer 3 is shown coupled to a power brick 16 through a USB connection with the computer 3 displaying a visualization of the attached circuit accomplished by scanning the circuit and its connections. The host computer 3 connection can allow for a multitude of circuit related visualizations and tasks including but not limited to, analyzing power states, control features, circuit configurations, logic analyzing, generating functions, providing tutorials, sharing online, and allowing for a user help interface.

Accordingly, this computer 3 interface in combination with the microcontrollers in the main hub brick 11, allows a user, upon requesting the device, to determine all of the connections between the various IO knobs. This is accomplished by setting all of the IO knobs to input, and then setting one knob at a time to high. Therefore, the device can know all of the IO connections by reading all the other IO knob states. Under this control, the entire state of an assembled circuit device can be saved on another device, such as a computer, or displayed. This other device would then have full knowledge of all hubs, specialized bricks, and IO connections. Additionally, this feature allows for the miswiring of IO knobs to be shown on the device itself through some type of notification, such as a flash or alert. Still further, as the device has full knowledge of all attached specialty bricks 10 and all IO knob connections, it is possible to run the circuit of the device at different speeds, in different directions, and to pause the circuit. This is useful to allow for a better understanding of the operation of the circuit.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of the specification.

What is claimed is:

1. A simplified circuit building device resembling a construction-style brick and adapted for engagement with a construction-style brick, the device comprising:
at least a pair of bricks, the bricks adapted for engagement with each other, each brick of the pair of bricks including:
at least one stud portion, the at least one stud portion having a top side and a bottom side, the top side forming a cylindrical knob, the cylindrical knob having a first conductive surface extending to the bottom side for conductive engagement with a printed circuit board; and
at least one receptacle portion, the at least one receptacle portion having a cavity, the cavity sized and shaped to receive the cylindrical knob, the cavity including a second conductive portion, the second conductive portion in conductive communication with the printed circuit board and in conductive communication with the first conductive surface of the cylindrical knob of one brick of the pair of bricks selectively placed within the cavity, wherein each brick of the pair of bricks can be cooperatively engaged in a conductive assembly.

2. A device as in claim 1, wherein the stud portion is comprised of a solid brass tube in conductive communication with the printed circuit board.

3. A device as in claim 2, wherein the solid brass tube is gold plated.

4. A device as in claim 1, wherein the receptacle second conductive portion is a spring loaded pin positioned within a central portion of the cavity.

5. A device as in claim 4, wherein the spring loaded pin exerts a spring tension force less than thirty (30) grams.

6. A device as in claim 1, wherein at least one brick of the pair of bricks includes a power source.

7. A device as in claim 6, wherein the at least one brick has four knob portions, one knob portion of the four knob portions capable of transmitting a first power signal, a second knob of the four knob portions capable of transmitting a second power signal, a third knob of the four knob portions capable of transmitting a serial protocol, and a fourth knob of the four knobs capable of receiving a serial protocol

8. A device as in claim 7, wherein the at least one brick includes at least two spring loaded pins positioned central to the four knobs, the at least two spring loaded pins adapted for transmission of a programming signal, wherein the at least one brick can be used for debugging of a constructed circuit.

9. A simplified circuit building device resembling a construction-style brick and adapted for engagement with a construction-style brick, the device comprising:
a main hub brick, the main hub brick comprising:
a top side;
a bottom side; and
a printed circuit board, the printed circuit board positioned internal to the main hub brick between the top side and the bottom side and adapted for conductive communication with the top side and the bottom side;
the top side including a plurality knob portions, the knob portions cylindrical, raised, and generally sized for engagement within a cavity of a construction-style brick, the knob portions arranged in six rows and a fixed number of columns, the central two rows of the six rows having conductive knob surfaces in communication with the printed circuit board and arranged in a 2×2 pattern with a first pair of knobs and a second pair of knobs opposed the first pair of knobs, the first pair of knobs comprised of a power knob and a ground knob, the second pair of knobs comprised of a transmission knob and a receiving knob, the transmission knob transmitting a serial protocol signal, the receiving knob receiving a serial protocol signal;
the bottom side including a plurality of receptacles, the receptacles positioned below the knob portions and having a cavity, the cavity sized and shaped for engagement with a knob portion of a construction-style brick, the cavity including a conductive surface, the conductive surface in communication with the printed circuit board and corresponding conductive knob portions; and
at least one specialty brick, the specialty adapted for engagement with the main hub brick knob portion or receptacle portion, the at least one specialty brick including:
at least one stud portion, the at least one stud portion having a top side and a bottom side, the top side forming a cylindrical knob, the cylindrical knob having a first conductive surface extending to the bottom side for conductive engagement with at least one receptacle portion; and
the at least one receptacle portion having a cavity, the cavity sized and shaped to receive the cylindrical knob, the cavity including a second conductive portion, the second conductive portion in conductive communication with the first conductive surface of the cylindrical knob of one brick of the pair of bricks selectively placed within the cavity, wherein the specialty brick is adapted for cooperative conductive engagement with either a receptacle portion of the main hub brick or the knob portion of the main hub brick.

10. A device as in claim 9, wherein the specialty brick includes a printed circuit board, the printed circuit board in conductive engagement with the at least one stud portion and the at least one receptacle portion.

11. A device as in claim 9, wherein the printed circuit board is adapted to perform analog to digital convertor (ADC) measurements.

12. A device as in claim 9, wherein the knob portion is comprised of a solid brass tube in conductive communication with the printed circuit board.

13. A device as in claim 12, wherein the solid brass tube is gold plated.

14. A device as in claim 9, wherein the receptacle second conductive portion is a spring loaded pin positioned within a central portion of the cavity.

15. A device as in claim 14, wherein the spring loaded pin exerts a spring tension force less than thirty (30) grams.

16. A device as in claim 9, wherein the specialty brick is adapted for engagement with a power source.

17. A device as in claim 16, wherein the specialty brick has four knob portions, one knob portion of the four knob portions capable of transmitting a first power signal, a second knob of the four knob portions capable of transmitting a second power signal, a third knob of the four knob portions capable of transmitting a Universal Asynchronous Receiver/Transmitter (UART) signal, and a fourth knob of the four knobs capable of receiving a Universal Asynchronous Receiver/Transmitter (UART).

18. A device as in claim 17, wherein the specialty brick includes a plurality of spring loaded pins positioned central to the four knobs, the plurality of spring loaded pins adapted for transmission of a programming signal, wherein the at least one brick can be used for debugging of a constructed circuit.

19. A device as in claim 9, wherein the specialty brick includes circuitry adapted to emulate a logical function, wherein this specialty brick will impart a logic function to adjacent LED and IO main hub brick knobs.

20. A device as in claim 11, wherein the specialty brick includes circuitry adapted to contain passive components having a current value corresponding to the main hub brick ADC.

21. A device as in claim 9, wherein the exterior two rows of the six rows of knobs include an exterior row of input/output (IO) knobs, and an inner row positioned inner the exterior row including light emitting diodes (LEDs).
